(19) United States
(12) Patent Application Publication
(10) Pub. No.: US 2011/0262743 A1
(43) Pub. Date: Oct. 27, 2011

(54) ENVIRONMENTALLY FRIENDLY ADHESIVE TAPE PAPER AND ADHESIVE TAPE MADE THEREFROM

(75) Inventors: Michael RAIDT, Rosenheim (DE); Oliver NICKEL, Bad Aibling (DE)

(73) Assignee: NEENAH GESSNER GMBH, Bruckmuehl (DE)

(21) Appl. No.: 13/091,845

(22) Filed: Apr. 21, 2011

(30) Foreign Application Priority Data
Apr. 21, 2010 (EP) 10 160 548.3

(51) Int. Cl. B32B 7/12; B05D 5/10; D21H 11/14

(52) U.S. Cl. 428/343; 162/135; 427/207.1

(57) ABSTRACT

The present invention relates to a paper for adhesive tapes having an impregnated paper support containing recycled cellulose fibers as well as to adhesive tapes comprising such a paper for adhesive tapes and an adhesive layer. The recycled cellulose fibers are only slightly ground and originate predominantly from the group of long-fibered softwood celluloses. If necessary, the adhesive tape paper is provided with a separating layer and a bonding agent layer.

### FIELD OF THE INVENTION

This invention relates to a paper for adhesive tapes (adhesive tape paper) having an impregnated paper support containing recycled cellulose fibers, to an adhesive tape containing such an adhesive tape paper as well as to methods of producing the adhesive tape papers and adhesive tapes.

### BACKGROUND OF THE INVENTION

Adhesive tapes made of an extensible paper support which is provided with a plastics impregnation and has an adhesive layer on one side and an adhesive-repellent layer on the opposite side, have been known for a long time. These adhesive tapes are wound on a core made of board or plastics to give a roll. Here, the adhesive-repellent layer of the adhesive tape paper, which is often referred to as a separating layer or also as a “release coat”, directly contacts the adhesive layer. The adhesive-repellent impact of the separating layer is matched with the adhesive force of the particular adhesive employed. As a result, the individual layers of an adhesive tape roll strongly adhere to one another such that they do not separate spontaneously, causing the adhesive tape roll to fall apart. On the other hand, the adhesion of the adhesive to the separating layer is not strong enough for the adhesive tape to tear off when it is peeled off the roll. Such adhesive tapes are described in DE 38 35 507 A1, for example.

These adhesive tapes are mainly used for masking objects during painting and varnishing, in the production and processing of electronic components and for sealing packages. Having been used, the adhesive tapes are thrown away and end up in waste combustion or on the waste site. From an environmental point of view, this is not an optimum step in particular if for the production of the adhesive tapes primary raw materials, e.g. primary celluloses, are used for the paper support.

In order to improve the environmental friendliness of adhesive paper tapes, it was tried to supply them to waste paper recycling. On account of their structure it is, however, not possible to recover the cellulose fibers from most of the adhesive paper tapes during waste paper processing. The adhesive paper tapes act like plastics films. They are rejected in the waste paper process and also end up on the waste site or are combusted.

Some efforts were made in the past to recover at least part of the rather high-grade and valuable cellulose fibers.

For example, German patent specification DE 42 11 510 C2 describes an adhesive packing tape which can be recycled and printed. In this case, a sized kraft paper made of long-fiber sulfate cellulose is used as a paper support, which was produced according to the Clupak method. It is thus possible to dispense with an impregnation of the paper support. Since the impregnation is dispensed with, at least part of the cellulose fibers can be recovered during waste paper processing. However, a drawback of this adhesive tape is that when the paper support is dissolved in the waste paper process the adhesive layer is comminuted and not completely removed from the pulp. In the further course of paper production, these adhesive residues then interfere with the production as they create holes and sticky deposits and cause the paper web to tear off.

In addition, an impregnation of the paper support can only be dispensed with for adhesive tapes which, after use, do not have to be removed from the covered background without leaving any residue, as is the case for adhesive packing tapes. Adhesive tapes for painting and varnishing usually adhere very strongly to the background such that a non-impregnated paper support splits if it is tried to tear off the adhesive tape. Splitting or delamination means that the adhesive tape paper tears off in itself, i.e. parallel to the adhesive tape, when it is removed so that the adhesive layer and part of the adhesive tape paper are left on the covered background. This is, of course, undesirable.

A conceivable alternative approach serving for obtaining more environmentally friendly adhesive tapes might be to replace valuable, high-grade primary raw materials with recycled raw materials, e.g. to replace primary celluloses with recycled cellulose fibers in the case of adhesive tape papers. As a result, it would no longer be necessary to fell and process trees for this disposable article, i.e. the adhesive paper tape.

DE 44 04 045 A1 makes an attempt in this direction. This publication describes an adhesive tape for use as a lint roller where the support tape is fully made of recycled waste paper. This document points out that papers made of recycled waste paper have a small inner strength and therefore are generally not suited for use as a support for adhesive tapes. The invention according to DE 44 04 045 A1 is only possible because a very weak adhesive is used at the same time. This adhesive binds lints and dirt but only adheres very weakly to the rear side of the paper support and to tables, for example. According to the teaching of DE 44 04 045 A1 the adhesive force of the bonding adhesive is said to be generally smaller than the inner strength of the support tape (paper support). This serves for avoiding the paper support to split and tear off due to its small inner strength when a layer of the adhesive tape is wound off the lint roller. DE 44 04 045 A1 does not discuss either the type of recycled cellulose employed or the production process of the adhesive tape paper. An adhesive tape according to this teaching is fully unsuited for technical use. The adhesive is far too weak to reliably adhere to most surfaces. if, however, the adhesive force of the adhesive was increased, the adhesive would adhere excessively to the rear side of the adhesive tape paper and the adhesive tape would tear because of its very small inner strength in the attempt to wind off one or more layers. Even if was possible to remove a layer of adhesive tape from the roll, it would not be possible to easily remove it from the covered article again since on account of its small inner strength it would split here as well.

JP 06-248244 A describes a release paper for adhesive tapes, which may also consist of recycled waste paper among other products. This publication does not specify the type of waste paper fiber employed and the production process either. The release paper has a separating layer made of a silicone compound to which even very strong adhesives adhere only slightly and therefore can be removed again with very little effort. The inner strength is usually irrelevant in this connection. However, in contrast to adhesive tape papers, release papers are not coated with an adhesive to then be adhered to an article. They rather serve as a protective layer for the adhesive of an adhesive tape prior to use. Before the adhesive tape is to be adhered to an article, the release paper is pulled off the adhesive. Assuming that such a release paper per se was coated with an adhesive, the inner strength of the described release paper would again be too small to remove it completely from the covered article without leaving any residue. The inner strength or splitting resistance is the force which has to be overcome to split a paper web into two individual layers.

Thus, there was a need for environmentally friendly adhesive tapes which simultaneously have excellent mechanical properties to be usable for masking articles in painting and varnishing, in the production and processing of electronic components and as adhesive packing tapes, for example.

### SUMMARY OF THE INVENTION

The object of the present invention is to provide an adhesive paper tape and an adhesive tape paper usable therein, which is more environmentally friendly than conventional adhesive tapes as described in DE 38 35 507 A1, for example, and which still has the required strength and resilience to be suitable for use in masking articles in painting and varnishing, in the production and processing of electronic components and as adhesive packing tapes.

This object is achieved according to the invention by a paper for adhesive tapes, which comprises an impregnated paper support and is characterized in that the paper support contains recycled cellulose fibers. Advantageous embodiments of the adhesive tape paper follow from claims 2 to 11. An adhesive tape comprising such an adhesive tape paper and an adhesive layer is the subject matter of claim 12.

The preamble of claim 1 here reflects the teaching of DE 38 35 507 A 1. Advantageous embodiments of the invention are described in the other claims.

Surprisingly enough, the inventors have found that adhesive tape papers including an impregnated paper support containing recycled cellulose fibers have mechanical properties which are relevant for said applications and are almost the same as those of an adhesive tape paper made of high-grade primary cellulose. This could not be expected from an expert point of view. The reason is that it had to be expected that due to their short fiber lengths e.g. the recycled cellulose fibers originating from waste paper would have strengths too small in order to be usable in adhesive tape papers for the above described fields of application.

### DETAILED DESCRIPTION OF THE INVENTION

### Exemplary Embodiments

The adhesive tape according to the invention, which is in particular an adhesive paper tape, comprises an impregnated paper support that contains recycled cellulose fibers and is provided with an adhesive layer on at least one side thereof. In order to better fix the adhesive layer, the adhesive tape paper may additionally be coated with a bonding agent before the adhesive is applied. If the applied adhesive is a pressure sensitive adhesive and only one side of the adhesive tape paper is provided with an adhesive layer, it is advantageous to provide the other side of the adhesive tape paper with an adhesive-repellent separating layer. In order to increase softness and smoothness, the impregnated adhesive tape paper can be calendared before the adhesive is coated.

The present application uses the term “recycled” cellulose fibers synonymously with “recovered” cellulose fibers. These cellulose fibers are recovered from waste paper, for example. The amount of recycled cellulose fibers in the impregnated paper support is preferably >50%, more preferably ≧90% and even more preferably ≧95%, based on the total cellulose fibers contained therein (i.e. recycled cellulose fibers+non-recycled, i.e. primary, cellulose fibers). According to a particularly preferred embodiment, the impregnated paper support exclusively contains recycled cellulose fibers and no primary cellulose fibers, i.e. non-recycled cellulose fibers, in the adhesive tape paper according to the invention.

Recycled cellulose fibers particularly suited according to the invention have proven to be those recovered from unsized group 4 waste paper grades (kraft grades) according to the “European list of standard grades of recovered papers (CEPI/B.I.R.) and their qualities”, July 2000. Preferred waste paper grades are tissue papers, tissue kraft papers and sulfate boards. These waste paper grades are characterized by high strengths and a low grinding degree or freeness of the cellulose fibers contained therein. They contain a particularly great amount of softwood cellulose fibers (e.g. spruce, pine tree, etc.). Softwood cellulose fibers generally have a markedly greater fiber length than cellulose fibers made from broadleaf trees. Correspondingly, it is advantageous as regards the strength of the adhesive tape paper according to the invention for the recycled cellulose fibers to be long-fiber softwood cellulose fibers.

The recycled cellulose fibers employed according to the invention advantageously have the properties listed in the below table. In order to measure these properties, a laboratory sheet having a weight per unit area of 70 g/m² and consisting of 100% recycled cellulose fibers to be investigated was produced according to the Rapid-Köthen method.

The production method according to Rapid-Köthen is to be described in more detail below. The cellulose to be investigated was dried at 105° C. in a circulation air drying cabinet for 4 hours. 24 g of the thus dried cellulose was increased to a cellulose-water volume of 2000 ml by the addition of tap water for the purpose of disintegration, followed by corresponding comminution. The suspension is then supplied to the disintegration container. The disintegration is carried out at a propeller rotating speed of 3000 rpm for precisely 25 minutes at a container content temperature of 15 to 20° C. At the time of sampling serving for forming the laboratory sheet, the distribution state of the cellulose fibers in the cellulose suspension has to be quite uniform. This is achieved by good mixing using suitable mixing vessels. For example, the pulp suspension may be transferred to a distributor. Then, the mixture is diluted using tap water to a cellulose-water volume of 9000 ml. Thereafter, the distributor is started and the suspension is mixed until it is filled into the 1 liter measuring cylinders for at least 2 minutes and no more than 10 minutes.

A Rapid-Köthen sheet formation and drying system is used for the actual formation of the laboratory sheet and drying thereof. This system is equipped with a couch roller (diameter (102-130 mm), length (240-260 mm), weight (3±0.2 kg); lateral surface made of felt having a thickness of 20 mm), for example.

Having an aspired weight per unit area of 70 g/m², about 800 ml of the resulting pulp suspension are filled into the 1 l measuring cylinders. The filling chamber of the Rapid-Köthen sheet formation and drying system is flooded with water. Air is pressed into the filling chamber which contains about 4-5 l of water and the pulp suspension is poured in. Swirling is allowed for 5 seconds, the air supply is stopped and the water is sucked off as quickly as possible. Thereafter, air is sucked through the sheet for 10 seconds. A paper cover sheet is placed centrically onto the wet sheet. The couch roller is allowed to roll back and forth into two mutually orthogonal directions without additional pressure over the sheet in 2 seconds. The sheet formation screen is removed from the support screen, turned over and its edge is smacked in slightly inclined fashion onto a horizontal base such that the wet sheet and the cover sheet fall down. 1 minute after couching at the latest, the wet sheet resting on the cover sheet is placed on the support screen of the drier. Another cover sheet is placed on top of the wet sheet, the drier is then closed immediately and evacuated by means of a vacuum pump. The drying step is carried out for 8-10 minutes at about 96° C. and with a partial vacuum of 95 kPa.

In this application, a test sheet produced in this way from the cellulose fibers whose properties are to be investigated is referred to as a laboratory sheet formed according to the Rapid-Köthen method.

The standard relevant for the Rapid-Köthen method is DIN EN ISO 5269-2.

The recycled cellulose fibers which are used according to the invention in a particularly beneficial fashion have the properties listed in the below table (laboratory sheet formation according to Rapid-Köthen; laboratory sheet weight 70 g/m²):

| | | |
|---|---|---|
| Breaking length | m | >3500, |
| | | preferably >5000 |
| Breaking strength | N/15 mm | >35, preferably >55 |
| Freeness | °SR | <50, preferably <22 |
| Suction height | mm | >0, preferably >20 |
| Tear strength in | mN | >500, |
| transverse direction | | preferably >600 |

The paper support is made from the paper pulp containing recycled cellulose fibers according to the prior art as known, possibly existing dirt particles in the paper pulp being removed by conventional graders. In the paper pulp, the amount of recycled cellulose fibers is as mentioned above, i.e. preferably >50%, more preferably ≧90% and even more preferably ≧95%, based on the total of cellulose fibers contained therein. It is particularly preferred for the paper pulp to consist of unsized group 4 waste paper grades (kraft containing grades) according to the “European list of standard grades of recovered paper (CEPI/B.I.R.) and their qualities”, July 2000. The paper pulp is ground with the grinding units common for the production of adhesive tape paper, preferably with a maximum energy input that is only 40 to 80%, more preferably 50 to 70% of the energy input required for grinding primary, long-fiber softwood sulfate celluloses. The grinding is advantageous to increase the strength of the paper support. It is additionally possible to provide the paper pulp, if required, with the additives common in paper production, such as wet strength agents, retention agents, fillers and/or dyes.

The paper web of the paper support may additionally be given a higher stretch or extension. This may be done, for example, by wet creping, dry creping or the Clupak method but is not limited to these examples. Every process providing the paper web with an additional stretch is suitable for the production of the paper support.

In the wet creping method, the moist web adhering to the surface of a cylinder is already removed in the paper machine by means of a scraper abutting the cylinder. A difference between the driving speed of the creping cylinder and that of the following transfer and drying unit, which may be adjusted to 2 to 50%, causes the paper web to be “creped” by this amount, i.e. to be made shorter by this amount due to the production of fine crimps.

The dry creping method operates according to a similar principle except that the creping is made outside the paper machine. The already dried paper is moistened before it is fed to the creping apparatus.

In the Clupak method, the still moist paper web is compacted between a rotary roller and a rotating elastic web, usually a rubber blanket. As a result, the extensibility of the paper is obtained with a very smooth surface.

The thus produced paper support has a weight per unit area of 30 to 100 g/m². preferably 35 to 60 g/m², an elongation at break of 2 to 20%, preferably 5 to 15%, a breaking strength in dry condition and longitudinal direction of 25 to 100N/15 mm, preferably 25 to 60 N/15 mm, a breaking strength in dry condition and transverse direction of 20 to 80 N/15 mm, preferably 10 to 20 N/15 mm, a splitting strength of at least 1.7 N/15 mm, preferably of at least 2.5 N/15 mm, and a thickness of 0.05 to 0.150 mm, preferably 0.100 to 0.120 mm.

The paper support is subsequently impregnated. This means that the paper support is soaked with an impregnating agent. A distinction has to be made between an impregnation and an only superficial coating. The impregnation is necessary to provide the adhesive tape paper according to the invention and an adhesive tape made thereof with the necessary strength and flexibility and create a non-absorbent base for the subsequent coatings. Suitable impregnating agents are polymer dispersions, polymer solutions or mixtures thereof.

In consideration as polymer dispersions are e.g. aqueous dispersions made of acrylic acid esters, polyvinyl acetate, acrylonitrile butadiene rubber, acrylic acid ester-styrene copolymers, ethylene-vinyl acetate copolymers, styrene butadiene rubber, phenolic resin, epoxide resin, natural rubber or mixtures thereof.

Suitable polymer solutions are e.g. polyvinyl alcohol in water, starch in water, phenolic resin in methanol, epoxide resin in methanol or mixtures thereof.

An impregnating agent particularly suited according to the invention is an aqueous styrene-butadiene-rubber dispersion having a glass transition temperature between −30° C. and +10° C., preferably between −10 and +5° C. The impregnating agent amount is between 5% by weight and 50% by weight, preferably between 10% by weight and 20% by weight, of the dry dispersion, based on the weight of the paper support to be impregnated.

Various additives and/or fillers may be added to the impregnating agent. Examples of additives are dyes, crosslinkers, hydrophobing agents, oil-repellent agents, hydrophilizing agents or mixtures thereof. For example, kaolin, titanium dioxide, talcum, calcium carbonate, silicon dioxide or mixtures thereof may be used as fillers.

In a special embodiment of the adhesive tape paper, a separating layer is applied to one side of the impregnated paper support. This separating layer may be produced by applying an aqueous dispersion based on acrylic acid esters, polyvinyl acetate, acrylic acid-styrene copolymers, styrene butadiene rubber, long-chain fatty acid and/or fatty alcohol derivatives, paraffins, silicone compounds or mixtures thereof, for example. As a result of the mixing ratio of the components used in this connection, the effect of the separating layer can be matched with a large number of different adhesives. The application amount after drying (dry coating amount) is 1-5 g/m², preferably 2-3 g/m².

Another variant of the adhesive tape paper according to the invention results from the application of a bonding agent on the side of the impregnated paper support which is not provided with the separating layer, i.e. on the side which is coated with the adhesive in the production of the adhesive tape, so as to form a bonding agent layer. The bonding agent preferably consists of an aqueous dispersion based on natural latex, acrylonitrile butadiene rubber, styrene butadiene rubber, acrylic acid ester or mixtures thereof. The application amount after drying (dry coating amount) is 1-5 g/m², preferably 1-2 g/m².

Both the impregnating agent and the separating layer as well as the bonding agent may be admixed with various additives and/or fillers. Examples of additives are dyes, crosslinkers, hydrophobing agents, oil-repellent agents, hydrophilizing agents or mixtures thereof. For example, kaolin, titanium dioxide, talcum, calcium carbonate, silicon dioxide or mixtures thereof may be used as fillers.

The impregnation of the paper support and the coating of the impregnated paper support may be made either inside the paper machine or outside the latter in an impregnation and coating machine designed for this particular purpose. Suitable impregnating methods are e.g. size press, dip impregnation, foam impregnation, roll impregnation, or spraying. Suitable coating methods are e.g. roll doctor, doctor blade, air brush or roller application.

In order to increase surface smoothness and flexibility, it is possible to calendar the impregnated paper coated with the separating layer and/or bonding agent. It is here preferred for the adhesive tape paper according to the invention to pass through the gap of a pair of rollers consisting of a steel roller and a rubber roller at a splitting pressure of 30 to 300 N/mm, preferably 50 to 150 N/15 mm, the side with the separating layer contacting the steel roller. The calendar temperature is between 20° and 70° C., preferably between 60 and 70° C.

In order to produce the adhesive tape, the adhesive tape paper according to the invention is also provided with an adhesive layer. If the adhesive tape paper, has a separating layer, the adhesive is applied to the opposite side. The employed adhesive may be either a pressure sensitive adhesive or an adhesive activated by moistening using a solvent, preferably water, or by heat. In consideration are all types of adhesive known for adhesive paper tapes in the art. The selection of a suitable adhesive depends on the intended use of the adhesive tape according to the invention. The application weight of the adhesive ranges between 20 g/m² and 50 g/m², preferably between 30 g/m² and 35 g/m².

### Test Methods

Weight per unit area according to DIN EN ISO 536

Thickness according to DIN EN ISO 534 having a support pressure of 20 N and a measuring surface of 200 mm²

Breaking strength in dry condition and in longitudinal and transverse directions according to DIN EN ISO 1924-2

Elongation at break in dry condition and in longitudinal and transverse directions according to DIN EN ISO 1924-2

R=1000×F_{B}/(m_{A}×b×g) Breaking length:
R=breaking length
F_{B}=breaking strength in dry condition and longitudinal direction according to DIN EN ISO 1924-2
m_{A}=weight per unit area according to DIN EN ISO 536
b=width of the specimen in mm
g=9.01 m²/s

Suction height in longitudinal and transverse directions according to DIN ISO 8787

Tear resistance according to Elmendorf in accordance with DIN EN 21974 with a sample package of 4 paper sheets

Freeness according to Schopper Riegler DIN ISO 5267-1

### Splitting Strength:

A strip having a width of about 52 mm and a length of about 200 mm is cut out of an adhesive tape paper sample conditioned beforehand at 23° C. and 50% relative humidity for 24 hours. The side having a length of 200 mm here extends parallel to the running direction of the paper. A strip of the adhesive test tape Scotch 2836 having a width of 50 mm and a length of about 150 mm is then adhered to this sample. The adhesive test tape is adhered to the side of the adhesive tape paper sample to be examined that has the strongest adhesion with respect to the adhesive test tape. Then, the composite of the adhesive tape paper to be examined and the adhesive test tape are joined by pressing using a steel roller having a weight of 4.5 kg and a width of 50 mm. The steel roller is rolled manually twice over the composite without exerting an additional pressure (once back and once forth). Thereafter, 2 strips having a width of 15 mm and the entire length are cut out of this composite. The adhesive test tape is pulled off manually from one of the two sides where the adhesive tape paper to be examined protrudes such that the adhesive tape paper to be examined is split over the entire sample width. If the adhesion of the adhesive test tape on the adhesive tape paper to be examined is poor and if the splitting strength is very high, the adhesive tape paper to be examined must be carefully cut by a razor blade and then be further split by means of the adhesive test tape. The splitting strength is measured in a Roll type Z 0.5 universal testing machine of Zwick company, having the following settings:

Measuring range 0.5 F
Program splitting strength
speed 300 mm/min
clamp distance 50 mm
forward path 20 mm
test distance 80 mm

The manually removed Scotch 2836 adhesive test tape is clamped into the upper clamp of the tensile testing machine. The adhesive tape paper to be tested is clamped in the lower clamp of the universal testing machine such that the composite protrudes at an angle of 90° relative to the tensile direction. During the measurement, care must be taken that the splitting is made in the center of the adhesive tape paper to be tested and that not only individual fibers are pulled out of the paper surface. Measurements where the splitting is not made in the center are ignored and repeated. What is measured is the average force required to split the paper. The result is the mean value from two individual measurements.

### Example 1 (Exemplary Embodiment)

In order to produce the adhesive tape base paper, 100% waste paper of the tissue kraft paper grade, brown, available from C.A. Lensing Entsorgung GmbH was used under the designation of tissue kraft paper, brown/white. The cellulose fibers of this waste paper grade had the following properties (measured by means of a laboratory sheet, produced according to the Rapid-Köthen method in accordance with DIN EN ISO 5269-2; weight of the laboratory sheet 70 g/m²):

| | | |
|---|---|---|
| Breaking length | m | 5450 |
| Breaking strength | N/15 mm | 59.2 |
| Freeness | °SR | 32 |
| Suction height | mm | 21 |
| Tear strength in transverse | mN | 534 |
| direction | | |

A paper web was made as usual from the above described waste paper in a paper machine. The energy input during grinding was 10 kWh/100 kg fiber mass. The paper web was transferred in a still moist state on a creping cylinder from where it was removed by a scraper as described in DE 4019680 A1 and subsequently dried by means of a drying cylinder. The thus produced adhesive tape base paper (paper support) had the following properties:

| Weight per unit area: | 48.8 | g/m² |
|---|---|---|
| thickness | 0.127 | mm |
| breaking strength in dry condition | 39.7N/15 | mm |
| and longitudinal direction | | |
| breaking strength in dry condition | 16.9N/15 | mm |
| and transverse direction | | |
| elongation at break in dry condition | 7.0% | |
| and longitudinal direction | | |
| elongation at break in dry condition | 11.6% | |
| and transverse direction | | |
| suction height in longitudinal direction | 20 | mm |
| suction height in transverse direction | 25 | mm |
| suction height in toto | 45 | mm |

The paper support of the adhesive tape paper was then soaked in a dip impregnation with an aqueous styrene butadiene rubber dispersion of the Litex SX 1009 grade, available from Polymerlatex company, and subsequently dried. The rubber has a glass transition temperature of −6° C. The impregnation weight was 5 g/m² after drying, which corresponds to a percentage of 10.2%, based on the fiber amount.

In another process step, the impregnated paper was coated on one side with 3 g/m² of a separating layer consisting of Primal R253 of Rohm and Haas company and on the opposite side with 1 g/m² of a bonding agent consisting of Graftex 49 of Centrotrade company. The paper was fully dried after each coating step.

Finally, the impregnated and coated adhesive tape paper was calendared between a steel roller and a rubber roller at a splitting pressure of 50 N/mm and a temperature of 70° C. In this case, the side of the separating layer contacted the steel roller.

The properties of the thus produced impregnated and coated adhesive tape paper are listed in Table 1.

### Example 2 (Comparative Example)

In order to produce the adhesive tape base paper, NBSK grade cellulose, available from Canfor company under the designation of Interconti ECF 90, was used. The cellulose fibers of this cellulose grade had the following properties (measured by means of a laboratory sheet produced according to the Rapid-Köthen method in accordance with DIN EN ISO 5269-2; weight of the laboratory sheet 70 g/m²):

| | | |
|---|---|---|
| Breaking length | m | 3420 |
| Breaking strength | N/15 mm | 37.1 |
| Freeness | °SR | 14 |
| Suction height | mm | 78 |
| Tear strength in transverse | mN | 1064 |
| direction | | |

A paper web was made as usual from the above described cellulose in a paper machine. The energy input during grinding was 17 kWh/100 kg fiber mass. The paper web was transferred in a still moist state to a creping cylinder from where it was removed by a scraper as described in DE 4019680 A1 and then dried by means of a drying cylinder. The thus produced adhesive tape base paper had the following properties:

A wet creped paper web was made from the thus produced cellulose pulp according to a prior art method. It had the following properties:

| Weight per unit area: | 41 | g/m² |
|---|---|---|
| thickness | 0.100 | mm |
| breaking strength in dry condition | 38N/15 | mm |
| and longitudinal direction | | |
| breaking dforce in dry condition | 16N/15 | mm |
| and transverse direction | | |
| elongation at break in dry condition | 13% | |
| and longitudinal direction | | |
| elongation at break in dry condition | 5% | |
| and transverse direction | | |
| suction height in longitudinal direction | 30 | mm |
| suction height in transverse direction | 45 | mm |
| suction height in toto | 75 | mm |

The thus produced paper web was then impregnated by means of dip impregnation with an aqueous styrene butadiene rubber dispersion of the Litex 1009 grade, available from Polymerlatex company. The rubber had a glass transition temperature of −4° C. The impregnation weight was 15 g/m² after drying, which corresponds to a percentage of 40% by weight, based on the fiber amount.

In another process step, the impregnated paper was coated on one side with 3 g/m² of a separating layer consisting of Primal R253 of Rohm and Haas company and on the opposite side with 1 g/m² of a bonding agent consisting of Graftex 49 of Centrotrade company. The paper was fully dried after each coating step.

The properties of the thus produced adhesive tape paper are listed in Table 1.

TABLE 1

| | Example 1 | | Example 2 | |
|---|---|---|---|---|
| Weight per unit area | 65.1 | g/m² | 60.3 | g/m² |
| Thickness | 0.092 | mm | 0.098 | mm |
| Breaking strength in dry | 72.2N/15 | mm | 69.4N/15 | mm |
| condition and longitudinal | | | | |
| direction | | | | |
| Breaking strength in dry | 30.9N/15 | mm | 30.4N/15 | mm |
| condition and transverse | | | | |
| direction | | | | |
| Elongation at break in dry | 5.3% | | 10.0 | |
| condition and longitudinal | | | | |
| direction | | | | |
| Elongation at break in dry | 11.4% | | 10.4 | |
| condition and transverse | | | | |
| direction | | | | |
| Tear resistance in | 401 | mN | 389 | mN |
| longitudinal direction | | | | |
| Tear resistance in transverse | 534 | mN | 516 | mN |
| direction | | | | |
| Splitting strength | 2.65N/15 | mm | 4.2N/15 | mm |

The comparison of the two examples makes clear that in spite of the use of recycled cellulose fibers the adhesive tape paper according to the invention (Example 1) has almost the same properties as an adhesive tape paper made of high-grade primary cellulose (Example 2) and is thus suited for all conventional intended uses. The differences in the elongation at break in dry condition and longitudinal direction follow from the machine settings in the creping step and are not due to the different fiber application. As expected, the splitting strength of the paper according to the invention (Example 1) is lower than that of a paper having high-grade primary celluloses (Example 2). Surprisingly enough it is, however, high enough to comply with the requirements occurring during further processing and use.

1. A paper for adhesive tapes, comprising an impregnated paper support, wherein the paper support contains recycled cellulose fibers.

2. The paper for adhesive tapes according to claim 1, wherein the recycled cellulose fibers are softwood cellulose fibers.

3. The paper for adhesive tapes according to claim 1, wherein the recycled cellulose fibers originate from unsized waste paper grades of group 4 according to the European List of CEPI/B.I.R.—standard grades.

4. The paper for adhesive tapes according to claim 1, wherein the grinding degree of the recycled cellulose fibers is less than 50° Schopper Riegler.

5. The paper for adhesive tapes according to claim 1, wherein a laboratory sheet, which consists of 100% recycled cellulose fibers, has a weight per unit area of 70 g/m² and is formed according to the Rapid-Köthen method, has a breaking strength in dry condition of at least 35 N/15 mm and/or a suction height of more than 0 mm.

6. The paper for adhesive tapes according to claim 1, wherein the splitting strength of the impregnated paper support is greater than 1.7 N/15 mm.

7. The paper for adhesive tapes according to claim 1, wherein one side of the paper support is provided with a separating layer.

8. The paper for adhesive tapes according to claim 7, wherein the paper support has a bonding agent layer on the opposite side of the separating layer.

9. The paper for adhesive tapes according to claim 7, wherein said paper is calendared.

10. The paper for adhesive tapes according to claim 9, wherein the paper is calendared between a steel roller and a rubber roller at a splitting pressure of 30 to 300 N/mm and a temperature between about 20° C. and 70° C.,

11. The paper for adhesive tapes according to at claim 1, wherein the amount of recycled cellulose fibers in the impregnated paper support is >50%, preferably ≧90%, based on the total of cellulose fibers contained therein.

12. An adhesive tape, comprising a paper for adhesive tapes according to claim 1 and an adhesive layer.

13. A method of producing a paper for adhesive tapes according to claim 1, wherein the paper pulp containing recycled cellulose fibers and optionally additives for paper production is ground and processed into a paper support web which is subsequently impregnated.

14. The method of producing an adhesive tape, comprising the application of an adhesive onto the paper for adhesive tapes according to claim 1.

15. (canceled)

16. The paper for adhesive tapes according to claim 1, wherein the amount of recycled cellulose fibers in the impregnated paper support is greater than 90%, based on the total of cellulose fibers contained therein.

17. The method of producing an adhesive tape, comprising the application of an adhesive onto the bonding agent larger according to claim 8.
